(19) United States
(12) Patent Application Publication
(10) Pub. No.: US 2004/0148208 A1
(43) Pub. Date: Jul. 29, 2004

(54) Method for evaluating the readiness of an organization

(76) Inventor: George B. Weathersby, Skillman, NJ (US)

Correspondence Address: L. Joseph Marhoefer, c/o Ronald R. Snider, Snider & Associates, P.O. Box 27613, Washington, DC, 20038-7613, US

(21) Appl. No.: 10/352,858

(22) Filed: Jan. 29, 2003

(51) Int. Cl. G06F 17/60

(52) U.S. Cl. 705/7

(57) ABSTRACT

A method collects data from individuals about the organization itself, and provides a measurement of an organization's relationship to its members who are relevant to execution. The method incorporates a set of interrelated, heuristic, leading indicators of success, including the following: Awareness; Own Role; Agreement; Preparation; and Recognition.

### BACKGROUND OF THE INVENTION

1. Field of the Invention

This invention relates to a method for evaluating the readiness of an organization to execute and implement one or more of the organization's strategies, and more particularly to a method that both measures quantitatively the capacity and capability of the organization to implement its strategy and also identifies areas for management actions that are likely to increase the organization's capacity and capability.

2. Description of the Prior Art

A small group at the top of an organization can establish policy, strategy, and objectives. But execution occurs at the level of individuals throughout the organization. Linking organization policy and/or strategy to the to the actions of each individual member of the organization is difficult and this linkage is not the result of the typical command and control structure of the organization. Information available to leaders in an organization is filtered by the hierarchy of the organization and is in the form of lagging indicators (e.g., financial results, number of sales calls, units produced).

Typically an organization has no leading indicators of its capability to execute or likelihood of executing its policies and strategies in the future. In addition, prior art methods for evaluating an organization typically collect responses from members of the organization about their own feelings, competencies, attitudes, motivation, and the like. These methods typically ask a series of questions of members, but with each question treated in isolation. That is, the structure of the questions does not provide a linkage among the questions and the overall evaluation does take into account response to one question in relation to the response to another question.

### SUMMARY OF THE INVENTION

An object of this invention is the provision of a method that can quantitatively measures an organization's capability to execute a specified set of policies or strategies at any point in time, including before the organization adopts the policy or strategy.

Another object of the invention is to quantitatively identify specific barriers to execution and to predict the forms of management intervention that will most likely be effective in successfully executing the policies and strategies.

A further object of this invention is the provision of a method to measure characteristics of an organization by focusing on attributes of the organization itself.

A still further object of the invention is the provision a method in which statements used to elicit information about the organization have a pre-designed structure that enables the resulting information to be combined as an index of the organization's readiness.

Briefly, this invention provides a method that collects data from individuals about the organization itself, and provides a measurement of an organization's relationship to its members who are relevant to execution. The method incorporates a set of interrelated, heuristic, leading indicators of success, including the following: Awareness; Own Role; Agreement; Preparation; and Recognition. Awareness provides a quantitative measure of the organization's communication of the policy or strategy to each member. Own Role measures the organization's communication of each member's a role in achieving each specific policy or strategy. Agreement measures the degree to which the organization has achieved unanimity that the strategy or policy is best for the organization. Preparation measures the degree to which the organization has provided the information, skills, and tools to enable each person to fulfill his or her role in executing each policy or strategy. Recognition measures the organization's systematic recognition and reward of individuals for their contributions to the execution of each policy or strategy. This response data is combined and in a way that provides useful information about the organization, including, but not limited to, an Execution Capability Index (ECI) and a Key Success Factor Index (KSFI).

### BRIEF DESCRIPTION OF THE DRAWINGS

FIG. 1 is a block diagram of one embodiment of a hardware system that can be used to implement the method steps of this invention.

FIG. 2 is a flow chart illustrating one embodiment of the method steps in accordance with the teachings of this invention.

FIG. 3 is a flow chart of the method steps for determining a readiness index in accordance with the teachings of the invention.

FIG. 4 is a flow chart of the method steps for determining an execution capability index in accordance with the teachings of this invention.

FIG. 5 is a flow chart of the method steps for determining a key success factor index in accordance with the teaching of this invention.

### DESCRIPTION OF THE PREFERRED EMBODIMENTS

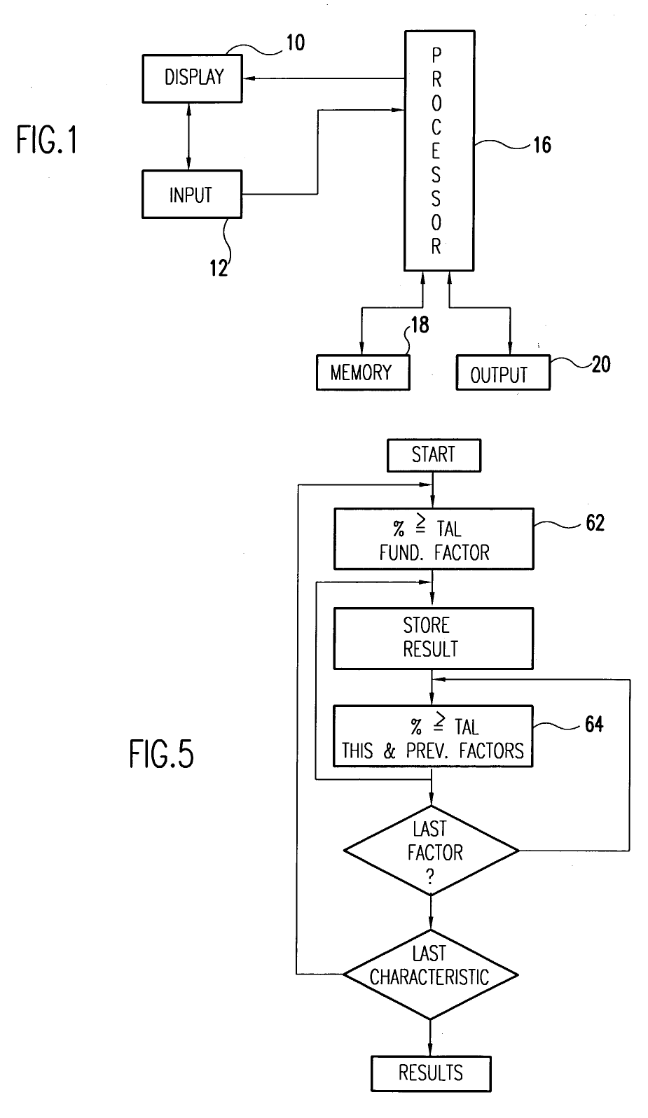

Referring now to FIG. 1 of the drawings, it shows an exemplary computer system for the practice of the invention. The system includes a display terminal 10 for display of items about the organization to which the member responds by means of an input device 12, such as a keyboard, or mouse, for example. The system includes a processor 16 and a memory 18 for processing response data and generating reports, which can be outputted at terminal 20, such as a printer, for example.

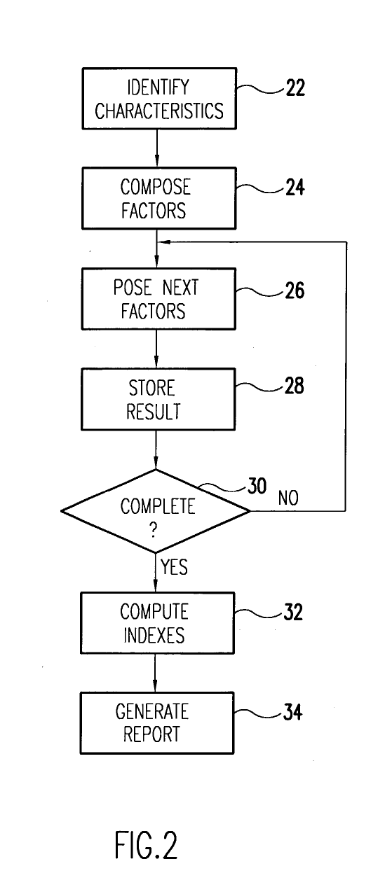

Referring now to FIG. 2 of the drawings, the process begins at block 22 with a determination of are the organization's characteristics upon which it places a priority. These characteristics are often components of the organization's strategy, business processes, people, or customers. In fact they can be any set of characteristics valued by the organization, such as business initiatives, corporate objectives, key brand attributes, elements of the mission statement, and the like. Next a set of factors to measure each characteristic is composed, block 24. These factors are a set of survey items directed to the organization itself as opposed to being directed to members of the organization. These factors are structured in a logical relationship, one to another, in order to facilitate the combination of the response data into indices of the organization readiness. In a preferred embodiment of the invention, a heuristic is used to generate the logical sequence of survey items to which responses are made on a quantitative scale (e.g. 1-5; 1-7: or any numerical or ordinal scale). A common set of factors is used for different characteristics. The following are examples of preferred factors; some or all of which can be used in combination with each other and can be used with other factors specific to the organization. The preferred factors are:

a. the organization has presented the essential nature and/or properties of the characteristic such that the member understands it;

b. the organization has presented the role of the member such that the member understands his or her role in the success of the characteristic;

c. the organization has generated support for the characteristic from the member;

d. the organization has provided the member with access to the tools and knowledge needed for success in his or her role in the characteristic;

e. the organization provides recognition and/or reward to the member for his or her successful accomplishment of his or her role in the characteristic.

Next, the factors are posed to the member for each characteristic, block 26. The factors are posed in the form of statements or questions, and elicit information about the organization. The member's quantitative response to each factor is stored, block 28. The process continues until the set of factors has been posed for each characteristic, as indicated in decision block 30. Next, in block 32, various indexes or scores are calculated from the member's responses stored in memory in step 28. Reports of these indexes or scores are generated at step 34.

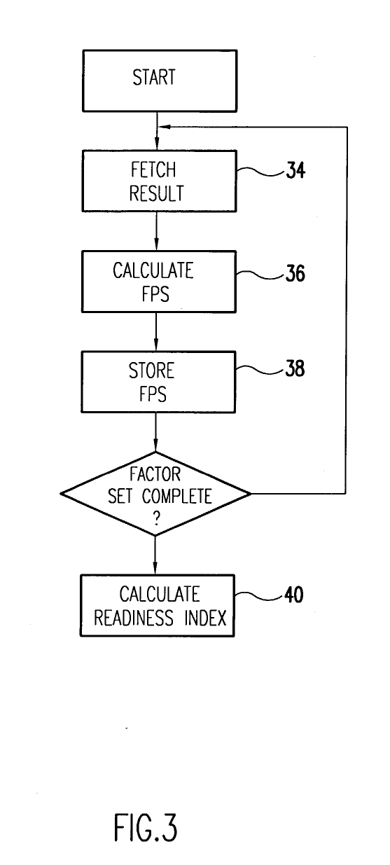

The process can calculate a variety of scores or indexes based upon an assessment, on a quantitative scale, of the factors posed to him or her. The indexes provide valuable information about the organization because of the logical inter relation and heuristic structure of the factors. FIG. 3 shows the process steps for determining a Readiness Index (RI) for an individual or group of individuals in the organization. The numerical responses of an individual or group of individuals is fetched from memory, block 34. A Target Achievement Level (TAL) factor converts the individual's number or the group's mean number for each factor related to a particular character to a percentage (FPS) by dividing the number by the TAL, block 36. The TAL is a number the organization has selected as a target for that factor and characteristic. The FPS is stored, block 38. The Readiness Index is calculated by multiplying together the FPS factors, block 40. It will be appreciated the RI for a characteristic is expressed is a percentage with the TAL as the base.

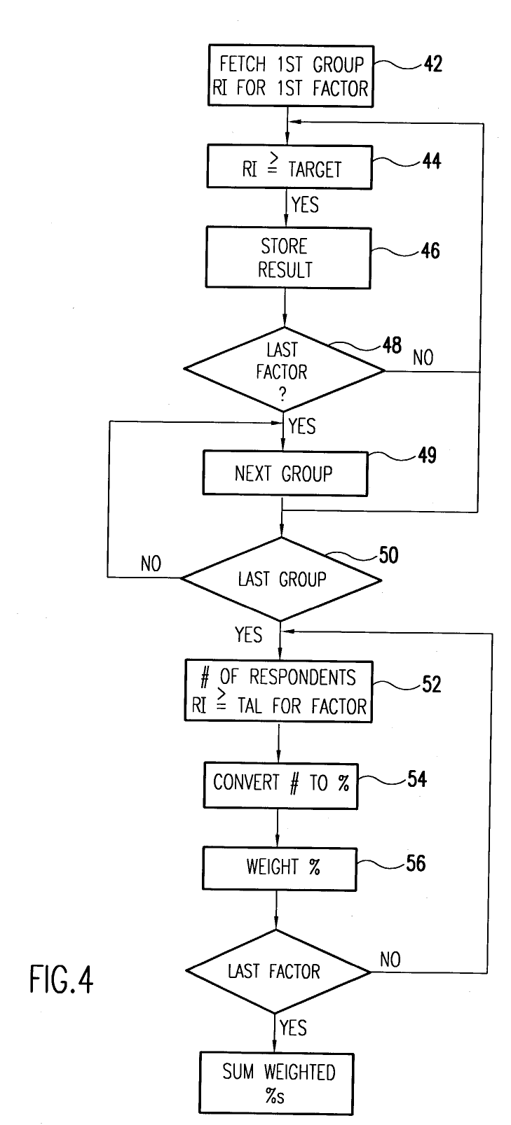

The ability of an organization to execute with respect to a characteristic or set of characteristics is not only a function of the RI for each characteristic but also the readiness across all or many characteristics and for all or many groups within the organization. An Execution Capability Index (ECI) is a measure of this ability. FIG. 4 shows the method steps in determining the ECI. The percentage of respondents of each group whose RI equals or exceeds the TAL for each factor is first determined by fetching the RI, block 42, comparing it with the TAL, block 44, and storing the results of the positive comparisons, block 46. This procedure is repeated for all or selected characteristics and for all or selected groups, blocks 48, 49 and 50. The number of respondents whose RI equals or exceeds the TAL for a factor is divided by the total number of respondents for that factor to give a percentage, blocks 52 and 54. Each percentage value is weighted by multiplying the percentage value for a factor by the ratio of the TAL for that factor to the sum of the TALs for all the factors being considered, block 56. The Execution Capability Index is the sum of the weighted percentages for all the factors or all of the factors being considered, block 58. It will be appreciated, the range of the ECI is 0 to 100% with the higher the index the higher the organizational capability for execution.

A Key Success Factor Index identifies the source of limitations in an organization's ability to execute its mission. This index is based upon the hierarchical relation of the statements or questions about the organization. As shown in FIG. 5, the first step (block 62) calculates he percentage of members with a response equal to or greater than the TAL for the most fundamental factor. In the example given above, this would be the awareness of the members. For the next factor in the hierarchy (e.g. my role) the percentage of members whose responds is equal to above the TAL both this and all previous factors is calculated, step 64. The process continues for all factors, each time including in the numerator of the calculation only those who have a score equal to or greater than the TAL for all previous factors. The denominator for the percentage calculation remains the entire group of members for all calculations. The process can continue to include all relevant characteristics, and the results reported in a matrix format with characteristics as rows and factors as columns, for example.

The process of this invention generates reports on the execution readiness of an organization that that are integrally linked to the structure of the method. A “Variance” report shows the RI as a bar with all parts in excess of the TAL for each characteristic shown in one color (e.g. green) and all parts with values less than the TAL shown in another color (e.g. red). With the same bar chart convention, a report can show columns with factor detail for each characteristic. A Detailed Execution Readiness report for any group of respondents shows the KSFI for factors in rank order as they exceed their TAL across some or all characteristics.

It is to be understood that the above-described embodiments are merely illustrative of the principles of the invention and that many variations may be devised by those skilled in the art without departing from the spirit and scope of the invention. It is, therefore, intended that such variations be included within the scope of the claims.

1. A computer method for providing data about an organization, including the steps of:
a) surveying members of the organization with respect characteristics of the organization;
b) said surveying step posing statements to said members as a series of factors that have a heuristic logical relation one to another;
c) members responding in said surveying step on a quantitative scale;
d) storing results of said surveying step;
e) calculating from said results a score or scores that provide an index of organizational readiness;
f) generating a report or reports based on said score or scores.

2. A computer method as in claim 1, wherein said factors include one or more of the following:
a) the organization has presented the essential nature and/or properties of characteristic such that the member understands the characteristic;
b) the organization has presented the role of members such that a member understands his or her role in the success of a characteristic;
c) the organization has generated significant support for a characteristic from a member;
d) the organization has provided a member with access to the tools and knowledge needed for success in his or her role with respect to the characteristic;
e) the organization systematically provides recognition and/or reward to a member for his or her successful accomplishment of his or her role with respect to the characteristic.

3. A computer method as in claim 1, wherein said scores includes the following score:
a readiness index (RI) calculated by dividing the member's result for each factor by a target achievement level for that factor to yield a factor percentage score (FPS) and then multiplying together the FPSs for a plurality of factors.

4. A computer method as in claim 1, wherein said scores includes the following score:
a readiness index (RI) calculated by converting result for a group of members to a mean or average for each factor and dividing the mean or average result by a target achievement level for that factor to yield a factor percentage score (FPS), and then multiplying together the FPS for a plurality of factors.

5. A computer method as in claim 1, wherein said scores include the following score:
an execution index calculated by determining the number of groups whose RI equals or exceeds the target achievement level for each of a plurality of factors, converting the number to a percentage by dividing the number by a number of groups, weighting each percentage by a factor equal to the target achievement level for a factor by the sum of the target achievement levels for the plurality of factors, and summing the weighted percentages.
